(19) United States
(12) Patent Application Publication
(10) Pub. No.: US 2026/0338468 A1
(43) Pub. Date: Oct. 29, 2026

(54) CROSS FLOW HEAT EXCHANGER FOR THE THERMAL TREATMENT OF MATERIALS IN THE FORM OF GRIT AND/OR GRANULES

(71) Applicant: ZEPPELIN Systems GmbH, Friedrichshafen (DE)

(72) Inventors: Hans SCHNEIDER, Lindau (DE); Marcus KOREHNKE, Weingarten (DE); Hermann BAIER, Eriskirch (DE)

(21) Appl. No.: 19/120,537

(22) PCT Filed: Oct. 11, 2023
(86) PCT No.: PCT/EP2023/078240

§ 371 Date: Apr. 11, 2025

(30) Foreign Application Priority Data
Oct. 11, 2022 (EP) 22200873.2

(51) Int. Cl. F26B 17/14; F26B 3/06; F26B 21/00; F26B 21/50

(52) U.S. Cl. CPC F26B 17/1425; F26B 3/06; F26B 21/002; F26B 21/50; F26B 2200/08

(57) ABSTRACT

The invention relates to a cross flow heat exchanger (1) for the thermal treatment of materials (18) in the form of grit and/or granules, consisting of a housing (4) with an upper material inlet (25), a process chamber (5) through which the material (18) moves, and a lower material outlet (26), wherein, starting from an air inlet side (16), the process chamber (5) is able to be flowed through by a temperature-controlled gas (19) in the direction of an air outlet side (17), wherein the cross flow heat exchanger (1) has, on the air inlet side (16), an air inlet chamber (7) having a chamber housing (13, 13′) which is terminated on one side by a perforated plate (9), and has, on the air outlet side (17), an air outlet chamber (8) having a chamber housing (13, 13″) which is terminated on one side by a screen (10).

The invention relates to a cross flow heat exchanger for the thermal treatment of materials in the form of grit and/or granules according to the pre-characterizing portion of claim 1.

A heat exchanger is understood to be a device that transfers thermal energy from one material flow to another. Heat exchangers of this type are used, for example, in process engineering systems, and can be configured as cross flow heat exchangers.

Cross flow heat exchangers carry out thermal treatment of powdery materials in the form of grit and/or granules. Such a cross flow heat exchanger is located, for example, in a recycling plant that treats contaminated bulk material (for example, granules) so that it can be used as a starting material for a new product in subsequent manufacturing or processing operations.

The cross flow heat exchanger conventionally consists of a process chamber through which the granules to be temperature-controlled are guided in a vertical direction. The process chamber has lateral connecting pieces through which an air flow is introduced into the process chamber. The air flow flows around the granules to be temperature-controlled and exits the process chamber on the opposite side.

EP 1 019 663 A1 discloses a drier-heat-exchanger for the thermal treatment of granular bulk materials. The heat exchanger consists essentially of a housing with a channel with air-permeable plates, through which the bulk material is passed. On the side of the housing there are several connecting pieces for the inlet and outlet of the process gas. The construction of the drier-heat-exchanger is very complex due to the subdivided chamber and the numerous lateral connecting pieces. It is therefore difficult to control the movement of the granules within the channel. The interior of the heat exchanger can, moreover, only be cleaned to a limited extent.

The task of the present invention is now to develop a cross flow heat exchanger in such a way that it is simpler in construction, performs more efficient thermal treatment and is easier to clean. The movement of the granules should, moreover, be easier to control with the cross flow heat exchanger.

To solve the task that has been set out, the invention is characterized by the technical teaching of claim 1.

An essential feature of the invention is that the cross flow heat exchanger has an air inlet chamber with a chamber housing on the air inlet side, which air inlet chamber is terminated on one side with a perforated plate, and has an air outlet chamber with a chamber housing on the air outlet side, which air outlet chamber is terminated on one side with a screen.

In a first preferred embodiment, the cross flow heat exchanger consists of a housing with a process chamber. The housing has a material inlet and a material outlet for the material in the form of granules. The material in the form of granules moves within the process chamber from top to bottom and preferably has a fixed bed condition. A gas flow flows through the process chamber. The gas flow is introduced by means of an air inlet chamber, flows through or respectively around the material in the form of granules and is discharged from the process chamber by means of an air outlet chamber.

The air inlet chamber and/or the air outlet chamber are detachably arranged on the housing of the cross flow heat exchanger. Due to the detachable arrangement, the air inlet chamber and the air outlet chamber can be removed from the housing and easily cleaned. Moreover, by means of the detachment of the air inlet and/or air outlet chamber, the process chamber is freely accessible and can also be easily cleaned.

The air inlet chamber and/or the air outlet chamber essentially consist of a chamber housing, which forms an accommodation for a perforated plate or a screen. Preferably, the perforated plate and/or the screen are detachably connected to the air inlet chamber and/or air outlet chamber.

The chamber housing is preferably box-shaped or cylindrical and terminated on one side with a perforated plate or a screen. The chamber housing thereby has a chamber volume for accommodating a certain quantity of the temperature-controlled gas, wherein the gas flows out of the chamber housing of the air inlet chamber through openings in the perforated plate and flows into the chamber housing of the air outlet chamber through gaps in the screen.

The perforated plate and/or the screen can be configured out of one or a plurality of parts. The perforated plate and the screen can, moreover, have any geometric shape and dimension. The decisive factor is that the perforated plate and the screen can be arranged in the chamber housing of the air inlet and air outlet chamber.

In a preferred embodiment, the air inlet chamber preferably has a perforated plate, which forms an air-permeable separation between the chamber housing of the air inlet chamber and of the process chamber. The arrangement of a perforated plate on the air inlet side has the significant advantage that the perforated plate has a simple design and is therefore relatively inexpensive. The perforated plate only needs to be permeable to air so that the gas flow can flow into the process chamber.

The perforated plate has a plurality of air-permeable openings. Preferably, the openings are configured in such a way that the gas flow, which flows into the air inlet chamber through the conduit, creates a certain back pressure and is distributed over the entire air inlet chamber. By distributing the air flow over the entire air inlet chamber, the gas flow is evenly distributed to the material in the form of granules in the process chamber. The air inlet chamber is therefore a kind of distribution element that distributes the gas flow evenly over the entire height of the process chamber. This allows the movement of the material in the form of granules to be better controlled and the material to be thermally treated more efficiently.

In contrast, in the prior art, the gas flow was blown into the process chamber at a plurality of individual points. This is tied in to the disadvantage that the material in the form of granules is exposed to the gas flow at several points, which has a negative effect on the movement of the material in the form of granules.

The air outlet chamber, preferably, has a screen that separates the gas flow from the material in the form of granules. The screen is, for example, configured as a slotted screen. Slotted screens require limited installation space, are low-maintenance and have a high degree of efficiency. Such slotted screens are virtually clog-free. The process chamber is configured by the shape of the perforated plate and by the shape of the screen.

The air inlet chamber and the air outlet chamber are each connected to conduits that feed or dissipate the temperature-controlled (heated or cooled) gas flow. The dissipated gas flow is, preferably, fed to another process within the process engineering system.

A collection container for the material in the form of granules is located above the housing on the product inlet side. The collection container is filled with the granules by means of a feed line. A metering device is, preferably, located in the area of the feed line.

For example, the collection container is permanently connected to the housing of the cross flow heat exchanger and forms a unit with the housing. It is, however, also possible that the collection container is configured as a separate unit that is detachably arranged to the housing of the cross flow heat exchanger. Due to the detachable connection, the collection container can be removed from the housing and easily cleaned.

In general, the shape of the air inlet and/or air outlet chambers is adapted to the housing shape of the cross flow heat exchanger. The housing of the cross flow heat exchanger is preferably angular and has, for example, a rectangular shape. The air inlet chamber and/or the air outlet chamber are also angular and adapted to the housing shape of the cross flow heat exchanger. It is, however, also possible for the housing to have a cylindrical or alternatively round shape.

In a further preferred embodiment, the chamber housings of the air inlet chamber and the air outlet chamber are configured equally. This means that the same chamber housing with the same dimensions can always be mounted on the housing of the cross flow heat exchanger, both on the air inlet side and on the air outlet side. The perforated plate and the screen are detachably connected to the chamber housing, so that the perforated plate and/or the screen can be mounted either in the chamber housing of the air inlet chamber and/or the air outlet chamber. The cross flow heat exchanger according to the invention is thereby a modular structure.

In a further preferred embodiment, the cross flow heat exchanger has a process chamber with the shape of an annular ring cross-section or alternatively a hollow cylinder. The material in the form of granules is introduced into the annular ring-shaped process chamber from above and moves downwards over the entire circumference of the annular ring. The gas flow is introduced either from below and/or from above into the (free) center of the annular ring, wherein the gas flow flows through the material in the form of granules from the inside to the outside. There is an annular ring perforated plate on the air inlet side. A screen, preferably a slotted screen, is located on the air outlet side. The perforated plate and the screen are arranged at a distance from each other and form the circular process chamber.

As a further variant, it is possible that the process chamber has the shape of an annular ring cross-section or hollow cylinder, wherein the gas flow passes through the process chamber from the outside to the inside. There is an annular ring perforated plate on the air inlet side. A screen, preferably a slotted screen, is located on the air outlet side.

The slotted screen can, for example, be configured as a screen plate, a curved slotted screen, a trommel or a cylinder.

The metering device or metering devices are used to control the material in the form of granules, which moves slowly within the process chamber from the top (material inlet) to the bottom (material outlet). The aim is to achieve a fixed bed within the process chamber. In so doing, this should avoid an air short circuit, in which the air inside the process chamber rises upwards against the direction of movement of the material in the form of granules, thereby equalizing the speed of movement of the individual granules.

The metering device is configured, for example, as a rotary valve, a slider, a metering screw, a double flap, a shut-off by means of a handwheel, a chain hoist, an electro-pneumatic shut-off or the like.

In a preferred embodiment, one metering device is located on the material outlet side of the cross flow heat exchanger. The metering device is used to control the continuous operation of the cross flow heat exchanger. This means that the material in the form of granules is always present as a solid bed in the process chamber, which is flowed through by the gas flow or alternatively air flow.

In a further preferred embodiment, there is one metering device on the material inlet side and one metering device on the material outlet side. With the upper metering device on the product inlet side, the uniform filling of the collection container can be controlled. Simultaneously, an air short circuit can also be avoided. The lower metering device is used to control the fill level within the collection container. Preferably, both metering devices (upper, lower) are connected to a control unit and are controlled by it. The upper metering device can be dispensed with if a sufficient bed of bulk material above the process chamber is present.

The collection container can, moreover, have a fill level indicator, which measures the fill level of the material in the form of granules inside the collection container and controls the upper and/or lower metering device as a function thereof.

The air inlet chamber is connected to a temperature control device via a conduit. The thermal energy can be generated, for example, by means of a gas burner, steam generator or hot water with a heat exchanger or electric heating coil. Waste heat from other process steps can also be used, for example, by means of a recuperator.

The temperature-controlled gas can be configured as a heating or cooling gas. The gas can, for example, be air.

A material is generally understood to be a material in the form of grit and/or granules. It is quite possible that the substance contains a certain content of moisture.

The cross flow heat exchanger according to the invention is preferably part of a process engineering system. By way of example, the cross flow heat exchanger can be combined with a deodorization system which removes volatile organic compounds (VOC) from the recycled plastics in a thermal process in continuous or discontinuous operation. In so doing, the plastic granules are initially heated to the required process temperature and subsequently flushed with air in a silo for a predetermined dwell time. In so doing, the air absorbs the volatile foreign substances. The heated exhaust air can be reused as process heat within the process engineering system. Energy costs, in particular, are thereby saved.

The subject matter of the present invention results not only from the subject matter of the individual patent claims, but rather also from the combination of the individual patent claims with each other.

All the information and features disclosed in the documents, including the summary, in particular the spatial configuration shown in the drawings, are claimed as being essential to the invention insofar as they are new, either individually or in combination, when compared to the prior art.

The invention is explained hereinafter, in more detail with the aid of drawings illustrating several embodiments. Further features and advantages of the invention that are essential to the invention are apparent from the drawings and their description.

Wherein:

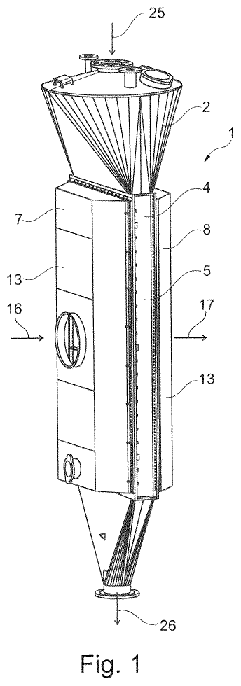

FIG. 1: shows a schematic representation of the cross flow heat exchanger

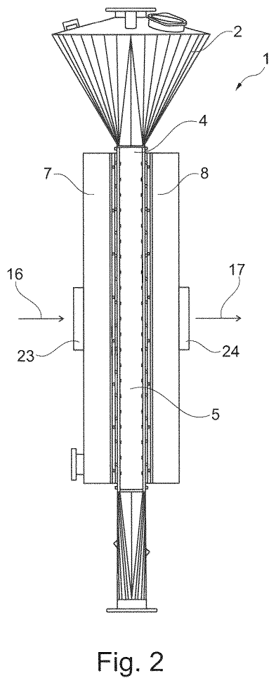

FIG. 2: shows a schematic side view of the cross flow heat exchanger

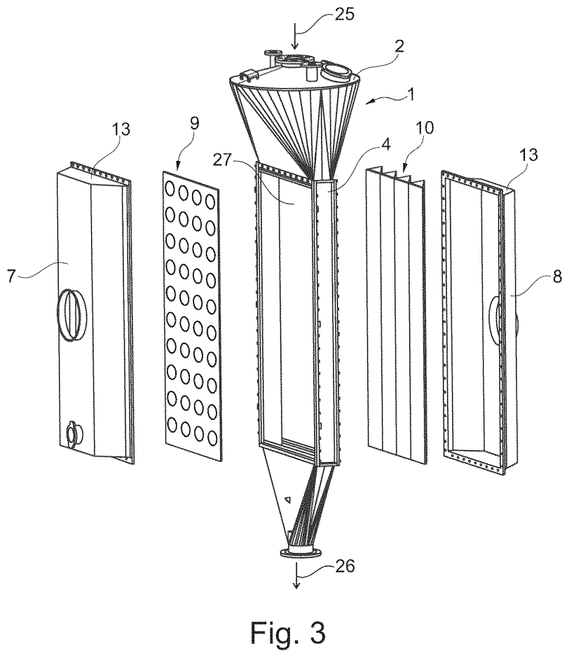

FIG. 3: shows an exploded view of the cross flow heat exchanger

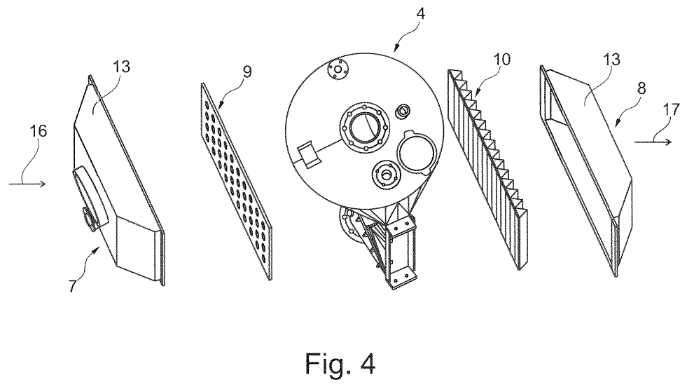

FIG. 4: shows an exploded view of the cross flow heat exchanger from above

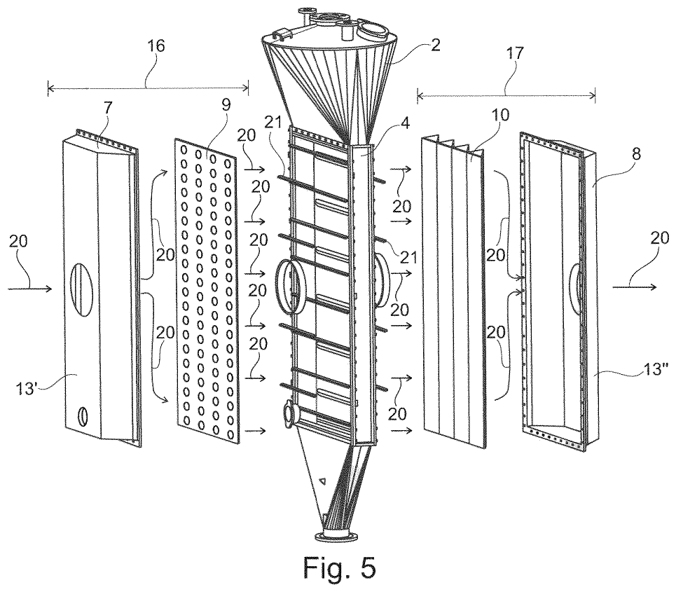

FIG. 5: shows an exploded view of the cross flow heat exchanger with reinforcements

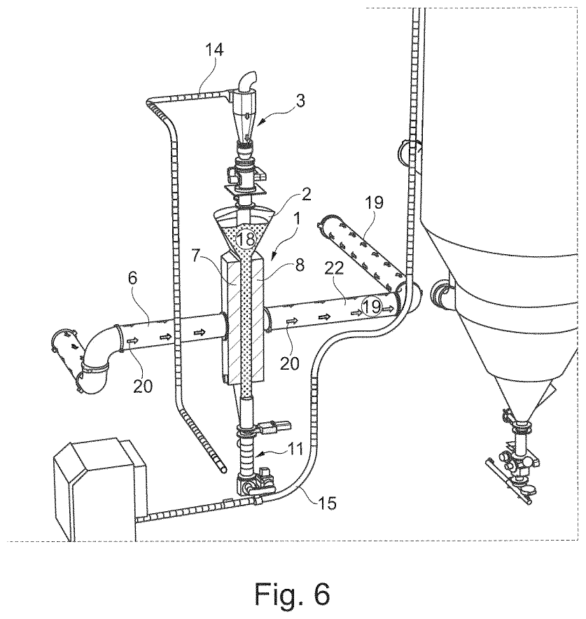

FIG. 6: shows a schematic representation of the cross flow heat exchanger within a process engineering system

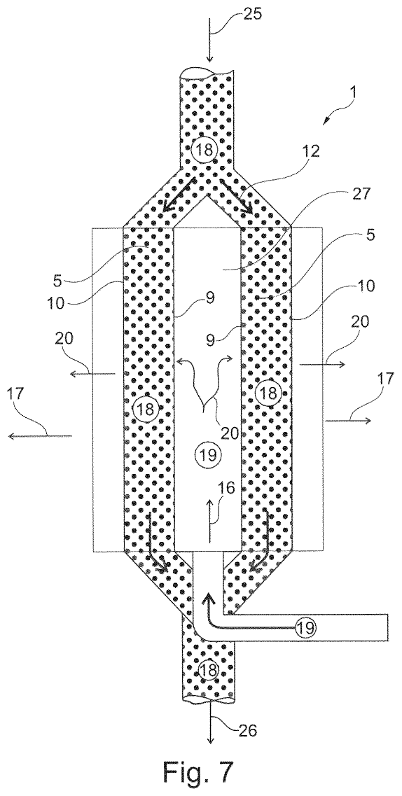

FIG. 7: shows a cross-sectional view of a further embodiment of the cross flow heat exchanger

FIG. 1 shows the cross flow heat exchanger 1. The cross flow heat exchanger 1 consists of a housing 4, on which respectively an air inlet chamber 7 and an air outlet chamber 8 are arranged. The process chamber 5 is located in the housing 4. The housing 4 is rectangular and has an open space 27 through which the gas 19 flows. A collection container 2 is located above the housing 4, in the area of the material inlet 25, which collection container receives a material 18 from a feed line 14 (see FIG. 6). The collection container 2 is conical in shape, whereby the material 18 easily moves in the direction of the process chamber 5. Simultaneously, the risk of an air short-circuit is reduced by the conical shape of the collection container 2.

The material outlet 26 is located on the opposite side of the housing 4, through which material outlet the material 18 is discharged from the cross flow heat exchanger 1. The collection container 2 serves as a storage container for the cross flow heat exchanger 1 and ensures that there is always a sufficient amount of material 18 in the process chamber 5.

The housing 4 of the cross flow heat exchanger 1 forms the basis for the two air inlet and air outlet chambers 7, 8, which are detachably arranged on the housing 4. The chamber housing 13 of the air inlet and of the air outlet chamber 7, 8 is configured to be identical. On the air inlet side 16, the air inlet chamber 7 has a connecting piece 23 for connecting a conduit 6. The temperature-controlled gas 19 is fed into the chamber housing 13 of the air inlet chamber 7 by means of the conduit 6. The air outlet chamber 8 has a connecting piece 24 for the connection of a conduit 22 on the air outlet side 17. The gas 19 is discharged from the chamber housing 13 of the air inlet chamber 8 by means of the conduit 22.

FIG. 2 shows a side view of the cross flow heat exchanger 1. The cross flow heat exchanger 1 has a relatively compact and simple design. An air inlet chamber 7 with only one connecting piece 23 is found on the air inlet side 16. An air inlet chamber 8 with likewise only one connecting piece 24 is found on the air inlet side 17.

FIG. 3 shows an exploded view of the cross flow heat exchanger 1. The cross flow heat exchanger 1 essentially consists of a housing 4, an air inlet chamber 7 and an air outlet chamber 8. A collection container 2 is present above the housing 4.

The air inlet chamber 7 consists of a chamber housing 13, into which a perforated plate 9 is inserted. The air outlet chamber 8 likewise consists of a chamber housing 13, into which a screen 10 is inserted. The perforated plate 9 and the screen 10 are detachably connected to the chamber housings 13.

The chamber housings 13 of the air inlet chamber 7 and the air outlet chamber 8 are preferably identical, whereby the construction of the cross flow heat exchanger 1 is relatively simple and can be manufactured inexpensively. The chamber housings 13, 13′ 13″ are box-shaped and can thereby accommodate a certain volume of the gas 19 or alternatively of the gas flow 20. The perforated plate 9 and the screen 10 respectively each close off one side of the chamber housing 13, 13′, 13″. In the assembled state, the chamber housing 13, 13′, 13″ is terminated, wherein the gas flow 20 can only still flow out of the chamber housing 13, 13′ through the openings in the perforated plate 9 and flow into the chamber housing 13, 13″ through the gaps in the screen 10.

In the assembled state, the perforated plate 9 and the screen 10 are arranged at a distance from each other and, in the space between them, form the process chamber 5 for the material 18.

According to FIG. 3, the screen 10 is configured as a slotted screen. The openings of the slotted screen 10 are configured in such a way that the material 18 is held back and gas 19 can flow through with a gas flow 20.

FIG. 4 shows a top view of the cross flow heat exchanger 1. The air inlet chamber 7 with the perforated plate 9 is located on the air inlet side 16. The air outlet chamber 8 with the screen 10 is located on the air outlet side 8. Both components 7, 8 are mounted on the housing 4 and form the process chamber 5.

FIG. 5 shows the individual components of the cross flow heat exchanger 1, as well as the gas flow 20 of the gas 19 within the cross flow heat exchanger 1.

The gas flow 20 is introduced into the chamber housing 13′ on the air inlet side 16, where it meets the perforated plate 9. The perforated plate 9 is configured in such a way that the gas flow 20 is backed up inside the chamber housing 13′, resulting in a homogeneous distribution of the gas flow 20. The gas flow 20 is thereby distributed in the chamber housing 13′ and released over the entire height of the process chamber 5. By distributing the gas flow 20 on the air inlet side 16, a uniform flow through the process chamber 5 of the cross flow heat exchanger 1 is achieved. The movement of the material 18 from top to bottom within the process chamber 5 is therefore not disturbed by the gas flow 20. This ensures that a fixed bed is always maintained.

The air outlet chamber 8 with the chamber housing 13″ and the screen 10 is located on the opposite air outlet side 17. After the flow of the gas 19 through the process chamber 5, the gas flow 20 initially hits the screen 10, which separates the gas 19 from the material 18. The gas flow 20 is subsequently brought together by the chamber housing 13″ and discharged through a conduit 22. The chamber housings 13, 13′, 13″ therefore act as a distribution element or collection element for the temperature-controlled gas 19.

According to FIG. 5, the housing 4 of the cross flow heat exchanger 1 has a plurality of reinforcements 21. The reinforcements 21 serve as supports or alternatively holding devices for the perforated plate 9 or alternatively the screen 10.

FIG. 6 shows the cross flow heat exchanger 1 according to the invention within a process engineering system. In the area of the material inlet 25, the cross flow heat exchanger 1 has a first metering device 3 with which a uniform filling of the collection container 2 with the material 18 via the conduit 14 is controlled. A second metering device 11 is located on the opposite material outlet side 26, which second metering device controls the movement of the fixed bed within the process chamber 5 and checks the fill level in the collection container 2.

The cross flow heat exchanger 1 has a conduit 6 on the air inlet side 16, with which a temperature-controlled gas 19 with a gas flow 20 is introduced into the air inlet chamber 7. The gas flow 20 is discharged on the opposite air outlet side 17, by means of a conduit 22.

FIG. 7 shows a further embodiment of the cross flow heat transfer medium 1. The cross flow heat transfer medium 1 has a round housing 4. The process chamber 5 is located in the housing 4. The perforated plate 9 and the screen 10 are arranged at a distance from each other and form the process chamber 5 between them, through which the material 18 moves in the arrow direction 12. The perforated plate 9 and the screen 10 thereby have a hollow cylindrical shape, wherein the material 18 moves through the intermediate space. A hollow cylinder or alternatively a hollow cylindrical shape is understood to mean a shape in which a smaller cylinder is cut out of a cylinder. The smaller, cut-out cylinder then forms the open space 27.

The open space 27 is in the center of the hollow cylinder, which open space forms the air inlet side 16. The temperature-controlled gas 19 is introduced into the open space with a gas flow 20, flows through the perforated plate 9, the process chamber 5 as well as the screen 10 and is again discharged out of the cross flow heat exchanger 1 on the air outlet side 17.

### DRAWING LEGEND

1. Cross flow heat exchanger
2. Collection container
3. Metering device (upper)
4. Housing
5. Process chamber
6. Conduit from 16
7. Air inlet chamber
8. Air outlet chamber
9 Perforated plate
10. Screen
11. Metering device (lower)
12. Arrow direction
13. Chamber housing of 7, 8
14. Feed line
15. Feed line
16. Air inlet side
17. Air outlet side
18. Material
19. Gas (temperature-controlled)
20. Gas
21. Reinforcement
22. Conduit from 17
23. Connecting piece from 16
24. Connecting piece from 17
25. Material inlet
26. Material outlet
27. Open space

1. A cross flow heat exchanger for the thermal treatment of materials in the form of grit and/or granules consisting of a housing with an upper material inlet, a process chamber through which the material moves and a lower material outlet, wherein, starting from an air inlet side, the process chamber can be flowed through with a temperature-controlled gas in the direction of an air outlet side, wherein the cross flow heat exchanger has an air inlet chamber with a chamber housing on the air inlet side, which air inlet is terminated on one side with a perforated plate, wherein the cross flow heat exchanger has an air outlet chamber with a chamber housing on the air outlet side which air outlet chamber is terminated on one side with a screen and wherein the screen is configured as a slotted screen.

2. The cross flow heat exchanger according to claim 1, wherein the air inlet chamber and the air outlet chamber are detachably connected to the cross flow heat exchanger.

3. The cross flow heat exchanger according to claim 1, wherein the perforated plate and/or the screen are detachably connected to the chamber housing.

4. The cross flow heat exchanger according to claim 1, wherein the chamber housings are terminated by the perforated plate or the screen, wherein the gas flows out of the chamber housing through openings in the perforated plate and flows into the chamber housing through gaps in the screen.

5. The cross flow heat exchanger according to claim 1, wherein the slotted screen is configured as a screen plate, curved slotted screen, trommel or cylinder.

6. The cross flow heat exchanger according to claim 1, wherein the perforated plate and the screen are arranged at a distance from each other on the housing and form the process chamber between them, through which the material moves as a fixed bed.

7. The cross flow heat exchanger according to claim 1, wherein the cross flow heat exchanger has a collection container in the area of the material inlet as a storage container for the material.

8. The cross flow heat exchanger according to claim 1, wherein the cross flow heat exchanger has a metering device in the area of the material outlet.

9. The cross flow heat exchanger according to claim 8, wherein the metering device is configured as a rotary valve.

10. The cross flow heat exchanger according to claim 1, wherein the cross flow heat exchanger has a metering device in the area of the material inlet and a metering device in the area of the material outlet, wherein a control system controls the two metering devices in such a way that the material is always present as a fixed bed in the process chamber.

11. The cross flow heat exchanger according to claim 1, wherein a fill level meter measures the fill level of the material in the collection container, wherein a control system controls at least one metering device as a function of the level.

12. The cross flow heat exchanger according to claim 8, wherein the chamber housing has a chamber volume for accommodating a certain quantity of the temperature-controlled gas.

13. The cross flow heat exchanger according to claim 1, wherein the perforated plate brings about a homogeneous distribution of the gas within the chamber housing and thereby the gas flows with a uniform gas flow through the process chamber.

14. The cross flow heat exchanger according to claim 1, wherein the perforated plate and the screen (10) have an angular or round shape.

15. The cross flow heat exchanger according to claim 1, wherein the perforated plate and the screen have the shape of a hollow cylinder, wherein the perforated plate and the screen are arranged at a distance from each other and form the process chamber between them, and wherein the gas flow of the gas starting from the center of the hollow cylinder flows through the perforated plate, the material, and the screen.
